(19) United States
(12) Patent Application Publication
(10) Pub. No.: US 2023/0012730 A1
(43) Pub. Date: Jan. 19, 2023

(54) ROOFING SHINGLE COMPOSITION

(71) Applicant: Owens Corning Intellectual Capital, LLC, Toledo, OH (US)

(72) Inventors: Julia L. Faeth, Westerville, OH (US); Laurand Lewandowski, Newark, OH (US); Michael Franzen, Lombard, IL (US); Shane Gillies, Forest Park, IL (US); Jonathan Verhoff, Granville, OH (US); Regis Vincent, Grigny (FR)

(21) Appl. No.: 17/942,292

(22) Filed: Sep. 12, 2022

Related U.S. Application Data
(63) Continuation of application No. 16/705,291, filed on Dec. 6, 2019.
(60) Provisional application No. 62/777,499, filed on Dec. 10, 2018.

(51) Int. Cl. C04B 26/26; C04B 22/00; C04B 24/12; E04D 1/20; E04D 1/22; C08L 95/00; C09D 195/00; C08K 3/013

(52) U.S. Cl. CPC C04B 26/26; C04B 22/00; C04B 24/126; E04D 1/20; E04D 1/22; C04B 24/124; C08L 95/00; C09D 195/00; C08K 3/013; C04B 2111/00594

(57) ABSTRACT

A roofing material is provided that comprises a coating composition including a filler and a bituminous composition comprising at least one bitumen base, at least one compound of general Formula (I): Ar1-R₁—Ar₂ (I), and at least one compound of general formula (II): R₂—(NH)ₙCONH—X—(NHCO)ₚ(NH)ₙ—R′₂ (II). The invention also concerns a process for the preparation of a roofing material comprising the coating composition.

### RELATED APPLICATIONS

This application is a continuation of U.S. patent application Ser. No. 16/705,291, filed Dec. 6, 2019, which claims priority to U.S. Provisional Application No. 62/777,499, filed Dec. 10, 2018, titled “ROOFING SHINGLE COMPOSITION”, the entire disclosures of which are incorporated by reference.

The invention is directed to a bituminous composition which is solid at ambient temperature, notably at high ambient temperature. The invention also relates to a process for the preparation of such bituminous composition. The bituminous composition according to the invention is suitable as binder or coating, notably for the preparation of asphalt shingles.

### STATE OF THE ART

Roofing materials, such as shingles, are installed on the roofs of buildings to give the roof an aesthetically pleasing appearance, but most of all to provide them protection from the elements and bad weather. Typically, the roofing material is constituted of a substrate such as glass fiber mat or an organic felt, an asphalt coating on the substrate, and a surface layer of protective and/or decorative granules embedded in the asphalt coating.

A common method for the manufacture of asphalt shingles is the production of a continuous sheet of asphalt material cut into individual shingles. In the production of asphalt sheet material, either a glass fiber or an organic felt mat is passed through a coater containing a hot liquid asphalt to form a tacky, asphalt coated sheet. Subsequently, the hot asphalt coated sheet is passed beneath one or more granule applicators, which discharge protective and decorative surface granules onto portions of the asphalt sheet material.

Asphalt materials used for the preparation of shingles are traditionally prepared from very hard bitumen bases, typically having a ring and ball softening point superior or equal to 80° C., preferably superior or equal to 90° C. The softening point of the bitumen base is an important parameter for the preparation of shingles. Bitumen bases with high softening points prevent and/or avoid melting problems which may be caused by extreme climate conditions, notably by high ambient temperatures. Such hard bitumen compositions are generally obtained by hardening, notably by oxidation, of bitumen bases. However, very few oil flows currently exploited in the world are capable of providing crude oil which, after refinement and oxidation processes, give access to bitumen bases having such grades. In addition, the availability of oxidized bitumen bases suitable for shingle applications is in constant decrease.

To compensate for this lack of raw material, the flows supplying the oxidation chambers are more and more mixed with road bitumen bases, which may be modified with polymers and/or other hardening agents in order to modify the properties of the oxidized bitumen material.

Oxidized asphalt is generally applied at elevated temperatures (often roughly 400° F.) and, due to a phenomenon known as “blow loss,” about 1.0 to 5.0 wt. % of the raw material is lost during the oxidation process. Additionally, oxidized coatings can be very viscous and thus difficult to apply to a glass mat during shingle production. Furthermore, shingles made with oxidized coatings tend to have low impact resistance.

Another main problem is the recycling of asphalt shingles. About 11 million tons of shingles are disassembled every year in the United States alone. However, only a small part of the recovered bituminous material is currently recycled, notably as road binder for the preparations of bituminous mixes. The difficulty in recycling asphalt shingles is essentially due to the very high oxidation degree of the bituminous material which affects the durability of the road, notably the fatigue resistance and the crack resistance of the obtained road material at low temperature.

Therefore, there is the need for a bituminous material which is suitable for the preparation of asphalt shingles and which may be prepared from any bitumen base.

In particular, there is the need for a bituminous material which is suitable for the preparation of asphalt shingles and which can be prepared from a non-oxidized bitumen base.

There is also the need for a recyclable bituminous composition suitable for use as a shingle coating in the preparation of shingles.

U.S. Pat. No. 7,918,930 discloses the preparation of bituminous compositions comprising at least one blowing additive of general formula Ar₁—R—Ar₂.

WO 2008/107551 teaches the reversible reticulation of bitumen compositions based on the use of organogelator additives. The obtained bituminous compositions have a penetrability, measured at 25° C., of from about 40 to 70 1/10 mm.

WO 2018/115729 discloses a binder composition, notably a bituminous composition, comprising at least one acid compound of general formula R—(COOH)z and at least one amide compound of general formula R′—(NH)ₙCONH—(X)ₘ—(NHCO)ₚ—(NH)ₙ—R″.

None of these documents discloses bituminous compositions comprising the association of the two additives as defined here-after.

The Applicant has surprisingly discovered a new bituminous composition which is solid at room temperature and which can be used for the preparation of asphalt shingles. The bituminous composition should be solid at room temperature such that it does not flow, which could result in shingles sticking together. It is important that a balance be struck between reducing shingle sticking and producing a shingle that is flexible, especially for installation in cold weather.

The bituminous composition according to the invention is advantageous in that it can be prepared from any bitumen base, in particular from oxidized and/or non-oxidized bitumen bases.

The invention is particularly remarkable in that it provides compositions comprising non-oxidized bitumen bases which are suitable for roofing applications, whereas the skilled professional usually considers that non-oxidized bitumen bases are not appropriate for such applications, unless otherwise modified, such as with the use of polymers.

Moreover, the Applicant has discovered that this new bituminous composition has equivalent, and even improved, physical properties, as compared to oxidized bitumen bases.

In particular, the bituminous composition according to the invention has an improved compressive strength, an increased ring and ball softening point, a reduced hot viscosity, and a lower deformability as compared to oxidized bitumen bases.

Otherwise, the bituminous composition according to the invention is advantageous in that it can be fully or partially recycled as road binder.

### SUMMARY OF THE INVENTION

Various embodiments of the subject invention are directed to a coating composition for a roofing material comprising about 20 wt. % to about 90 wt. % of a filler material and a bituminous composition comprising: a bitumen base selected from the group consisting of partially oxidized bitumen, non-oxidized bitumen, and deasphalted asphalt; and 0.1 to 10% by weight of at least one compound of general Formula (I), general Formula (II), or combinations thereof, wherein the compound of general Formula (I) comprises:

Ar1-R₁—Ar₂ (I), wherein:
Ar1 and Ar2 represent, independently of one another, an aromatic group comprising from 6 to 20 carbon atoms chosen among a benzene nucleus or a system of condensed aromatic nuclei, said hydrocarbon group being substituted by at least one hydroxyl group and optionally by one or more C₁-C₂₀ alkyl groups, and
R₁ represents an optionally substituted hydrocarbon divalent radical, the main chain of which comprises from 6 to 20 carbon atoms and at least one group chosen from the amide, ester, hydrazide, urea, carbamate and anhydride functional groups; and
the compound of general Formula (II) comprises:

R₂—(NH)ₙCONH—X—(NHCO)ₚ(NH)ₙ—R′2 (II)
wherein the R₂ and R′₂ groups, which are identical or different, represent a hydrocarbon chain comprising from 1 to 22 carbon atoms which is optionally substituted and which optionally comprises one or more heteroatoms, such as N, O or S, and R₂ can be H,
the X group represents a hydrocarbon chain comprising from 1 to 22 carbon atoms which is optionally substituted and which optionally comprises one or more heteroatoms, such as N, O or S, and
n and p are integers having a value of 0 or 1, independently of one another.

In any of the exemplary embodiments, the compound of general Formula (I) may be 2′,3-bis[(3-[3,5-di(tert-butyl)-4-hydroxyphenyl]propionyl)]propionohydrazide and the compound of general formula (II) may be chosen from compounds of general Formula (IIA):

R₂—CONH—X—NHCO—R′₂ (IIA)

wherein R₂, R′₂ and X are as defined above.

In any of the exemplary embodiments, the coating comprises from 0.4 to 5% by weight of one or several compounds of general Formula (I), with respect to the total weight of the bituminous composition. The coating composition may further include from 0.5% to 6% by weight of one or several compounds of general Formula (II), with respect to the total weight of the bituminous composition.

In any of the exemplary embodiments, the coating may comprise from 89 to 99.1% by weight of a bitumen base, from 0.4 to 5% by weight of one or several additives of general Formula (I), and from 0.5 to 6% by weight of one or several additives of general Formula (II), with respect to the total weight of the bituminous composition.

In any of the exemplary embodiments, the coating composition comprises from 94 to 98.6% by weight of a bitumen base, from 0.4 to 1% by weight of one or several additives of general Formula (I), and from 1 to 5% by weight of one or several additives of general Formula (II), with respect to the total weight of the bituminous composition.

The coating composition may have a penetrability at 25° C., measured according to standard EN 1426, from 15 to 30 1/10 mm and may have a ring-and-ball softening point, measured according to standard EN 1427, of from 80 to 120° C.

Further exemplary embodiments of the subject invention are directed to a roofing material comprising a base material and a coating composition applied to at least one side of the base material. The coating composition comprises a filler material and a bituminous composition comprising:
a bitumen base selected from the group consisting of partially oxidized bitumen, non-oxidized bitumen, and deasphalted asphalt; and
0.1 to 10% by weight of at least one compound of general Formula (I), general Formula (II), or combinations thereof:
wherein the compound of general Formula (I) comprises:

Ar1-R₁—Ar₂ (I), wherein:
Ar1 and Ar2 represent, independently of one another, an aromatic group comprising from 6 to 20 carbon atoms chosen among a benzene nucleus or a system of condensed aromatic nuclei, said hydrocarbon group being substituted by at least one hydroxyl group and optionally by one or more C₁-C₂₀ alkyl groups, and
R₁ represents an optionally substituted hydrocarbon divalent radical, the main chain of which comprises from 6 to 20 carbon atoms and at least one group chosen from the amide, ester, hydrazide, urea, carbamate and anhydride functional groups; and
the compound of general Formula (II) comprises:

R₂—(NH)ₙCONH—X—(NHCO)ₚ(NH)ₙ—R′2 (II)
wherein the R₂ and R′₂ groups, which are identical or different, represent a hydrocarbon chain comprising from 1 to 22 carbon atoms which is optionally substituted and which optionally comprises one or more heteroatoms, such as N, O or S, and R₂ can be H,
the X group represents a hydrocarbon chain comprising from 1 to 22 carbon atoms which is optionally substituted and which optionally comprises one or more heteroatoms, such as N, O or S, and
n and p are integers having a value of 0 or 1, independently of one another.

In any of the exemplary embodiments, the roofing material comprises a roofing shingle. The roofing shingle may have an average granule loss of less than 0.4 grams after 8 weeks of wet aging in accordance with ASTM D4977/D4977M.

The bitumen base may comprise partially oxidized bitumen having a penetrability P₂₅ of 18 1/10 mm to 22 1/10 mm.

The coating composition may have a penetrability at 25° C., measured according to standard EN 1426, from 15 to 30 1/10 mm and/or a ring-and-ball softening point, measured according to standard EN 1427, of from 80 to 120° C.

Yet further exemplary embodiments of the present inventive concepts are directed to a roofing shingle comprising: a base material and a shingle coating composition applied to at least one side of the base material. The shingle coating composition comprises a filler material; and a bituminous composition comprising at least a bitumen base, selected from the group consisting of partially oxidized bitumen, non-oxidized bitumen, and deasphalted asphalt; and at least one of a compound of general Formula (I), general Formula (II), or combinations thereof, wherein the compound of general Formula (I) comprises:

Ar1-R₁—Ar₂ (I), wherein:
Ar1 and Ar2 represent, independently of one another, an aromatic group comprising from 6 to 20 carbon atoms chosen among a benzene nucleus or a system of condensed aromatic nuclei, said hydrocarbon group being substituted by at least one hydroxyl group and optionally by one or more C₁-C₂₀ alkyl groups, and
R₁ represents an optionally substituted hydrocarbon divalent radical, the main chain of which comprises from 6 to 20 carbon atoms and at least one group chosen from the amide, ester, hydrazide, urea, carbamate and anhydride functional groups; and
the compound of general Formula (II) comprises:

R₂—(NH)ₙCONH—X—(NHCO)ₚ(NH)ₙ—R′2 (II)
wherein the R₂ and R′₂ groups, which are identical or different, represent a hydrocarbon chain comprising from 1 to 22 carbon atoms which is optionally substituted and which optionally comprises one or more heteroatoms, such as N, O or S, and R₂ can be H,
the X group represents a hydrocarbon chain comprising from 1 to 22 carbon atoms which is optionally substituted and which optionally comprises one or more heteroatoms, such as N, O or S, and
n and p are integers having a value of 0 or 1, independently of one another.

In any of the exemplary embodiments, the roofing shingle passes UL 2218 Class 4 impact resistance test.

### BRIEF DESCRIPTION OF THE DRAWINGS

The general inventive concepts, as well as embodiments and advantages thereof, are described below in greater detail, by way of example, with reference to the drawings in which:

FIG. 1 graphically illustrates granule adhesion test results, reporting the weight of displaced granules for mimic shingles formed using an oxidized coating and a coating formulated in accordance with the present inventive concepts.

FIG. 2 graphically illustrates the roofing shingle tear strengths of various exemplary shingle mimics tested in accordance with ASTM D3462.

FIG. 3 graphically illustrates granule loss (in grams) for various roofing shingle samples after 8 weeks of wet aging.

### DETAILED DESCRIPTION

The present invention will now be described with occasional reference to the illustrated embodiments of the invention. This invention may, however, be embodied in different forms and should not be construed as limited to the embodiments set forth herein, nor in any order of preference. Rather, these embodiments are provided so that this disclosure will be more thorough, and will convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

As used herein, the term “consists essentially of” followed by one or more characteristics, means that may be included in the process or the material of the invention, besides explicitly listed components or steps, components or steps that do not materially affect the properties and characteristics of the invention.

The expression “comprised between X and Y” includes boundaries, unless explicitly stated otherwise. This expression means that the target range includes the X and Y values, and all values from X to Y.

Aspects of the present invention relates to a bitumen composition that may be subjected to an elevated ambient temperature, in particular a temperature ranging up to 100° C., preferably from 20° C. to 80° C.

In some exemplary embodiments, the bitumen composition is solid at ambient temperatures. By “solid at ambient temperature” it is meant that the bitumen composition is in a solid state and exhibits a solid appearance at ambient temperature, whatever the conditions of transportation and/or of storage and/or of handling. More specifically, the bitumen composition retains its solid appearance throughout the transportation and/or storage and/or handling at ambient temperature. The bitumen composition does not creep at ambient temperature under its own weight and does not creep when it is subjected to forces of pressures resulting from the conditions of transportation and/or of storage and/or of handling.

The term “penetrability” is understood here to mean the “needle penetrability” or “pen value” measurement, which is carried out by means of an NF EN 1426 standardized test at 25° C. (P25) and/or ASTM D5/D5M. This penetrability characteristic is expressed in tenths of a millimeter (dmm or 1/10 mm). The needle penetrability, measured at 25° C., according to the NF EN 1426 standardized test, represents the measurement of the penetration into a bitumen sample, after a time of 5 seconds, of a needle, the weight of which with its support is 100 g. The standard NF EN 1426 replaces the equivalent standard NF T 66-004 of December 1986 with effect on Dec. 20, 1999 (decision of the Director General of AFNOR dated Nov. 20, 1999). The term “softening point” is understood to mean the “ring-and-ball softening point” measurement which is carried out by means of an NF EN 1427 standardized test. The ring-and-ball softening point corresponds to the temperature at which a steel ball of standard diameter, after having passed through the material to be tested (stuck in a ring), reaches the bottom of a standardized tank filled with a liquid which is gradually heated and in which the apparatus has been immersed.

In some exemplary embodiments, a bituminous composition is provided that includes a bitumen base and a compound of general Formula (I): Ar₁-R₁—Ar₂ (I), wherein: Ar₁ and Ar₂ represent, independently of one another, an aromatic group comprising from 6 to 20 carbon atoms chosen among a benzene nucleus or a system of condensed aromatic nuclei, the hydrocarbon group being substituted by at least one hydroxyl group and optionally by one or more C₁-C₂₀ alkyl groups, and R₁ represents an optionally substituted hydrocarbon divalent radical, the main chain of which comprises from 6 to 20 carbon atoms and at least one group chosen from the amide, ester, hydrazide, urea, carbamate and anhydride functional groups. Optionally, the bituminous composition further includes a compound of general formula (II):

R₂—(NH)ₙCONH—X—(NHCO)ₚ(NH)ₙ—R′2 (II)

wherein: the R₂ and R′₂ groups, which are identical or different, represent a hydrocarbon chain comprising from 1 to 22 carbon atoms which is optionally substituted and which optionally comprises one or more heteroatoms, such as N, O or S, and R₂ can be H, the X group represents a hydrocarbon chain comprising from 1 to 22 carbon atoms which is optionally substituted and which optionally comprises one or more heteroatoms, such as N, O, S, n, and p are integers having a value of 0 or 1, independently of one another.

### The Bitumen Base:

The term “bitumen” is understood to mean any bituminous composition composed of one or more bitumen bases and optionally comprising one or more additives.

Mention may first of all be made, among the bitumen bases which can be used according to the invention, of bitumen of natural origin, those present in natural bitumen or natural asphalt deposits or bituminous sands, and bitumen originating from the refining of crude oil.

In some exemplary embodiments, the bitumen bases are chosen from bitumen bases originating from the refining of crude oil or from bituminous sands. In some aspects, the bitumen base is chosen from bitumen bases originating from the refining of crude oil.

The bitumen bases can be chosen from bitumen bases or mixtures of bitumen bases originating from the refining of crude oil, in particular bitumen bases containing asphaltenes or pitches. The bitumen bases can be obtained by conventional processes for the manufacture of bitumen bases in refining, in particular by direct distillation and/or vacuum distillation of oil. These bitumen bases can optionally be visbroken and/or deasphalted (i.e., propane deasphalted asphalt) and/or air-rectified. It is standard to carry out the vacuum distillation of the atmospheric residues originating from the atmospheric distillation of crude oil. This manufacturing process consequently corresponds to the sequence of an atmospheric distillation and of a vacuum distillation, the feedstock supplying the vacuum distillation corresponding to the atmospheric distillation residues. These vacuum residues resulting from the vacuum distillation tower can also be used as bitumens. It is also standard to inject air into a feedstock generally composed of distillates and of heavy products originating from the vacuum distillation of atmospheric residues originating from the distillation of oil. This process makes it possible to obtain a blown or semi-blown or oxidized or air-rectified or partially air-rectified base. The various bitumen bases obtained by the refining processes can be combined with one another in order to obtain the best technical compromise. The bitumen base can also be a bitumen base from recycling.

The bitumen bases may be chosen from bitumen bases of hard or soft grade. In some exemplary embodiments, the bitumen bases have a penetrability at 25° C., measured according to standard EN 1426, less than or equal to 200 1/10 mm, such as less than or equal to 100 1/10 mm. The bitumen composition may be processed at manufacturing temperatures of between 100° C. and 200° C., such as between 140° C. and 200° C., or between 140° C. and 170° C. The bitumen composition is stirred for a period of at least 10 minutes, such as between 30 minutes and 10 hours, or between 1 hour and 6 hours. The term “manufacturing temperature” is understood to mean the heating temperature of the bitumen base or bases before mixing and also the mixing temperature. The temperature and the duration of the heating vary according to the amount of bitumen used and are defined by the standard NF EN 12594.

According to some aspects of the invention, oxidized bitumens can be manufactured in a blowing unit by passing a stream of air and/or oxygen through a starting bituminous base. This operation can be carried out in the presence of an oxidation catalyst, for example, phosphoric acid. Generally, the oxidation is carried out at elevated temperatures, of the order of 200 to 300° C., for relatively long periods of time typically of between 30 minutes and 2 hours, continuously or batchwise. The period of time and the temperature for oxidation are adjusted as a function of the properties targeted for the oxidized bitumen and as a function of the quality of the starting bitumen.

Advantageously, the bitumen bases are chosen from bitumens of natural origin; bitumens originating from bituminous sands; bitumens originating from the refining of crude oil such as the atmospheric distillation residues, the vacuum distillation residues, the visbroken residues, the semi-blown residues and their mixtures; and their combinations or from synthetic bitumens.

The invention is particularly remarkable for non-oxidized bitumen bases from which, in the absence of additives, it is impossible to obtain a bituminous composition suitable for roofing applications. In fact, the Applicant has discovered that providing a non-oxidized bitumen base with at least one of a compound of general Formula (I) and a compound of general Formula (II) allows obtaining a bituminous composition which is suitable for the preparation of a roofing shingle. Non-oxidized bitumen bases typically have a ring and ball softening point, measured according to standard EN 1427, less than or equal to 70° C., more particularly less than or equal to 65° C.

Non-oxidized bitumen bases generally have a Penetration Index (PI) value, also known as the Pfeiffer Index value, calculated according to the formula here, less than or equal to 2.0.

$$P I = \frac{1952 - 500 \times log ( {P}_{25} ) - 20 \times RBT}{50 \times log ( {P}_{25} ) - RBT - 120}$$

According to some exemplary embodiments of the invention, the bitumen base may comprise at least one polymer additive and/or at least one fluxing agent.

In some exemplary embodiments, the polymer additive comprises an elastomeric radial or linear polymer. In some exemplary embodiments, the polymer additive comprises a copolymer such as a linear or radial copolymer. In some embodiments the polymer additive comprises one or more of atactic polypropylene (APP), isotactic polypropylene (IPP), styrene-butadiene rubber (SBS), polychloroprene; polynorbornene; chloroprene rubber (CR), natural and reclaimed rubbers, butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), and vinylacetate/polyethylene (EVA), ethylene-methylacrylate copolymers (EMA); copolymers of olefins and unsaturated carboxylic esters such as ethylene-butylacrylates (EBA); polyolefinic copolymers; polyolefins such as polybutenes (PB) and polyisobutenes (PIB); copolymers of ethylene and esters of acryclic acid or methacrylic acid or maleic anhydride; copolymers and terpolymers of ethylene and glycidyl methacrylate; ethylene/propylene copolymers; and rubber. In other exemplary embodiments, the polymer additive comprises a linear polymer or a combination of linear and radial polymers. Examples of polymer modifiers are also disclosed in U.S. Pat. No. 4,738,884 to Algrim et al. and U.S. Pat. No. 3,770,559, to Jackson, the contents of which are incorporated herein by reference in their entirety. In some exemplary embodiments, the asphalt is modified with styrene-butadiene rubber SBS.

Additional additives may also be included in the bitumen composition. Such additives include, for example, vulcanization and/or crosslinking agents which are able to react with the polymer, notably with the elastomer and/or the plastomer, which may be functionalized and/or which may comprise reactive sites.

As vulcanization agents, mentions may be made by way of example of sulphur based vulcanization agents and its derivatives. Such vulcanization agents are generally introduced in a content of from 0.01% to 30% by weight, with respect to the weight of the elastomer.

As crosslinking agents, mentions may be made by way of example of cationic reticulation agents such as mono or polyacids; carboxylic anhydrides; esters of carboxylic acids; sulfonic, sulfuric, phosphoric or chloride acids; phenols. Such crosslinking agents are generally introduced in a content of from 0.01% to 30% by weight, with respect to the weight of the polymer. These agents are likely to react with the functionalized elastomer and/or plastomer. They may be used to complete and/or to substitute vulcanization agents.

The bituminous composition according to the invention may comprise from 80 to 99.8% by weight of one or several bitumen bases, including from 89 to 99.1% by weight, and from 94 to 98.6% by weight, with respect to the total weight of the bituminous composition.

### Compounds of General Formula (I)

The bituminous composition according to the invention comprises at least one compound of general Formula (I):

Ar₁-R₁—Ar₂ (I)

wherein:
Ar₁ and Ar₂ represent, independently of one another, an aromatic group comprising from 6 to 20 carbon atoms chosen among a benzene nucleus or a system of condensed aromatic nuclei, said aromatic group being substituted by at least one hydroxyl group and optionally by one or more C₁-C₂₀ alkyl groups, and
R1 represents an optionally substituted hydrocarbon divalent radical, the main chain of which comprises from 6 to 20 carbon atoms and at least one group chosen from the amide, ester, hydrazide, urea, carbamate and anhydride functional groups.

In some exemplary embodiments, Ar₁ and/or Ar₂ are substituted by at least one alkyl group comprising from 1 to 10 carbon atoms, advantageously in one or more ortho positions with respect to the hydroxyl group(s); more preferably Ar₁ and Ar₂ are 3,5-dialkyl-4-hydroxyphenyl groups, advantageously 3,5-di(tert-butyl)-4-hydroxyphenyl groups.

In some exemplary embodiments, R1 is in the para position with respect to a hydroxyl group of Ar₁ and/or Ar₂.

Advantageously, the compound of general Formula (I) is 2′,3-bis[(3-[3,5-di(tert-butyl)-4-hydroxyphenyl]propionyl)]propionohydrazide.

The bituminous composition according to the invention may comprise from 0.1 to 10% by weight of one of several compounds of general Formula (I), with respect to the total weight of the bituminous composition.

In some exemplary embodiments, the bituminous composition comprises at least 0.4% by weight of one or several compounds of general Formula (I), with respect to the total weight of the bituminous composition.

In other exemplary embodiments, the bituminous composition comprises from 0.4 to 5% by weight of one or several compounds of general Formula (I), including from 0.4 to 1.5% by weight, from 0.5 to 1.2% by weight, and from 0.6 to 1.0% by weight, with respect to the total weight of the bituminous composition.

### Compounds of General Formula (II)

The bituminous composition according to the invention comprises at least one compound of general Formula (II):

R₂—(NH)ₙCONH—X—(NHCO)ₚ(NH)ₙ—R′2 (II)

wherein:
the R₂ and R′₂ groups, which are identical or different, represent a saturated or unsaturated and linear, branched or cyclic hydrocarbon chain comprising from 1 to 22 carbon atoms which is optionally substituted by one or more hydroxyl groups or amine groups and which optionally comprises heteroatoms, such as N, O or S, C₅-C₂₄ hydrocarbon rings and/or C₄-C₂₄ hydrocarbon heterocycles comprising one or more heteroatoms, such as N, O or S, and R₂′ can be H;
the X group represents a saturated or unsaturated and linear, cyclic or branched hydrocarbon chain comprising from 1 to 22 carbon atoms which is optionally substituted and which optionally comprises heteroatoms, such as N, O or S, C₅-C₂₄ hydrocarbon rings and/or C₄-C₂₄ hydrocarbon heterocycles comprising one or more heteroatoms, such as N, O or S;
n and p are integers having a value of 0 or 1, independently of each other.

In some exemplary embodiments, the R₂ and/or R′₂ group comprises an aliphatic hydrocarbon chain of from 4 to 22 carbon atoms, such as those chosen from the C₄H₉, C₅H₁₁, C₉H₁₉, C₁₁H₂₃, C₁₂H₂₅, C₁₇H₃₅, C₁₈H₃₇, C₂₁H₄₃ and C₂₂H₄₅ groups.

In some exemplary embodiments, the X group represents a saturated linear hydrocarbon chain comprising from 1 to 22 carbon atoms, such as from 1 to 12 carbon atoms, from 1 to 10 carbon atoms, and from 1 to 4 carbon atoms.

In some exemplary embodiments, the X group is chosen from the C₂H₄ and C₃H₆ groups.

In some exemplary embodiments, the compound of general Formula (II) is chosen from those which satisfy the condition n=0.

The compound of general Formula (II) may be chosen from those which satisfy the condition: the sum of the number of carbon atoms of R₂, X, and R′₂ is greater than or equal to 10, including greater than or equal to 14, and greater than or equal to 18.

In some exemplary embodiments, the compound of general Formula (II) is chosen from those which satisfy the condition: the number of the carbon atoms of at least one of R₂ and R′₂ is greater than or equal to 10, including greater than or equal to 12, and greater than or equal to 14.

In some exemplary embodiments, the compound of general Formula (II) is chosen from those of general Formula (IIA):

R₂—CONH—X—NHCO—R′₂ (IIA)

wherein R₂, R′₂, m and X have the same definitions as above.

In the general Formula (IIA), the X group may represent a saturated linear hydrocarbon chain comprising from 1 to 22 carbon atoms, including from 1 to 12 carbon atoms, or from 1 to 4 carbon atoms. In some exemplary embodiments, the X group is chosen from the C₂H₄ and C₃H₆ groups.

The compound of general Formula (IIA) may be chosen from those which satisfy the condition: the sum of the numbers of the carbon atoms of R₂, X and R′₂ is greater than or equal to 10, including greater than or equal to 14, and greater than or equal to 18.

The compound of general Formula (IIA) may be chosen from those which satisfy the condition: the number of the carbon atoms of at least one of R₂ and R′₂ is greater than or equal to 10, including greater than or equal to 12, and greater than or equal to 14.

In some exemplary embodiments, the compound of general Formula (IIA) is chosen from hydrazide derivatives, such as the compounds C₅H₁₁—CONH—NHCO—C₅H₁₁, C₉H₁₉—CONH—NHCO—C₉H₁₉, C₁H₂₃—CONH—NHCO—C₁₁H₂₃, C₁₇H₃₅—CONH—NHCO—C₁₇H₃₅ or C₂₁H₄₃—CONH—NHCO—C₂₁H₄₃; diamides, such as N,N′-ethylenedi(laurylamide) of formula C₁₁H₂₃—CONH—CH₂—CH₂—NHCO—C₁₁H₃₁, N,N′-ethylenedi(myristylamide) of formula C₁₃H₂₇—CONH—CH₂—CH₂—NHCO—C₁₃H₂₇, N,N′-ethylenedi(palmitamide) of formula C₁₅H₃₁—CONH—CH₂—CH₂—NHCO—C₁₅H₃₁ or N,N′-ethylenedi(stearamide) of formula C₁₇H₃₅—CONH—CH₂—CH₂—NHCO—C₁₇H₃₅; monoamides, such as laurylamide of formula C₁₁H₂₃—CONH₂, myristylamide of formula C₁₃H₂₇—CONH₂, palmitamide of formula C₁₅H₃₁—CONH₂ or stearamide of formula C₁₇H₃₅—CONH₂. In certain exemplary embodiments, the compound of general Formula (IIA) is N,N′-ethylenedi(stearamide) of formula C₁₇H₃₅—CONH—CH₂—CH₂—NHCO—C₁₇H₃₅.

The bituminous composition according to the invention may comprise from 0.1 to 10% by weight of one or several compounds of general Formula (II), including from 0.4 to 6% by weight, from 0.5 to 5% by weight, and from 0.7 to 2.5% by weight, with respect to the total weight of the bituminous composition. In some exemplary embodiments, the bituminous composition according to the invention may comprise from 1 to 5% by weight of one or several compounds of general Formula (II), with respect to the total weight of the bituminous composition.

In some exemplary embodiments, the bituminous composition includes additives from only one of general Formula (I) and general Formula (II). Thus, an exemplary embodiment of the present invention may comprise a bituminous composition that excludes an additive from either Formula (I) or Formula (II).

### The Bituminous Composition

In some exemplary embodiments, the bituminous composition according to the invention comprises or consists essentially of: one or several bitumen bases, one or several additives of general Formula (I), and one or several additives of general Formula (II).

In some exemplary embodiments, the bituminous composition according to the invention comprises or consists essentially of: one or several bitumen bases, one or several additives of general Formula (I), and optionally, one or several additives of general Formula (II).

In some exemplary embodiments, the bituminous composition comprises or consists essentially of: from 80 to 99.8% by weight of one or several bitumen bases, from 0.1 to 10% by weight of one or several additives of general Formula (I), and from 0.1 to 10% by weight of one or several additives of general Formula (II), with respect to the total weight of the bituminous composition.

In some exemplary embodiments, the bituminous composition according to the invention comprises or consists essentially of: from 89 to 99.1% by weight of one or several bitumen bases, from 0.4 to 5% by weight of one or several additives of general Formula (I), and from 0.5 to 6% by weight of one or several additives of general Formula (II), with respect to the total weight of the bituminous composition.

In further exemplary embodiments, the bituminous composition according to the invention comprises or consists essentially of: from 94 to 98.6% by weight of one or several bitumen bases, from 0.4 to 1% by weight of one or several additives of general Formula (I), and from 1 to 5% by weight of one or several additives of general Formula (II), with respect to the total weight of the bituminous composition.

The bituminous composition according to the invention advantageously has a penetrability at 25° C., measured according to standard EN 1426, less than or equal to 40 1/10 mm, including from 5 to 40 1/10 mm, from 10 to 35 1/10 mm, and from 15 to 30 1/10 mm.

The bituminous composition according to the invention advantageously has a ring-and-ball softening point, measured according to standard EN 1427, of from 80 to 120° C., including from 90° C. to 115° C., and from 95° C. to 110° C.

The bituminous composition may have a maximum force (Fmax) greater than or equal to 5 N, including greater than or equal to 10 N, greater than or equal to 20 N, greater than or equal to 30 N, greater than or equal to 40 N, greater than or equal to 50 N, and greater than or equal to 60 N.

In some exemplary embodiments, the bituminous composition according to the invention has a maximum force of from 20 N to 200 N, more preferably from 30 N to 180 N, even more preferably from 40 N to 160 N, advantageously from 50 to 150 N, more advantageously from 60 to 100 N.

The maximum force (Fmax) may, for example, be measured with a texture analyzer commercialized by LLOYD Instruments under the name LF Plus and equipped with a thermal enclosure. The piston of the texture analyzer is a cylinder having a diameter of 25 mm and a height of 60 mm.

A cylindrical metallic box comprising 60 g of the bituminous composition to analyze is introduced inside the thermal enclosure settled at a temperature of 50° C. The cylindrical piston is initially placed in contact with the superior surface of the bituminous composition. Then, the piston is put in a vertical movement to the bottom of the box, at a constant velocity equal to 1 mm/min and over a calibrated distance of 10 mm in order to apply to the superior surface of the bituminous composition a compression strength. The texture analyzer measures the maximal force (Fmax) applied by the piston on the surface of the bituminous composition at 50° C.

The determination of the maximal force (Fmax) allows evaluating the capacity of the bituminous composition to resist to the deformation, when it is submitted to a specific mass having a constant applied velocity. The higher the maximal force (Fmax) is, the better the compression strength a bituminous block obtained from the bituminous composition.

The bituminous composition according to the invention may have a deformability at 65° C., of less than or equal to 50%, including less than or equal to 25%, less than or equal to 15%, such as from 1 to 15%, or from 1 to 10%.

The deformability of a bituminous composition may for example be determined according to the following protocol.

The bituminous composition to be analyzed is first poured in a circular silicon mold and then cooled at ambient temperature for at least 1 hour before being unmolded.

The lower plate of an ANTON PAAR Physica MCR 301 plate-plate rheometer is heated at a temperature of 65° C. Once the temperature has been reached, the rheometer is equipped with a PP25 mobile before being blanked. The gap of the rheometer is fixed at 2 mm. The unmolded solid bituminous composition is placed on the heated plan. The height of the mobile is then adjusted to 2.1 mm and the surplus of bituminous composition overflowing under the mobile is cut out by using a heated spatula. The gap of the rheometer is finally re-adjusted at 2 mm and the bell, previously heated at 65° C., is placed over the whole instrument. The measurement is launched as soon as the rheometer indicates a normal force value equal to 0 N. The constraint applied to the sample is set at 100 Pa and the acquisition time at 7,200 s.

The bituminous composition according to the invention may have a viscosity at 160° C., V₁₆₀, measured according to standard NF EN 13702, of less than or equal to 500 mPa·s, such as from 50 to 500 mPa·s, and from 100 to 250 mPa·s, from 120 to 200 mPa·s, and from 125 to 175 mPa·s.

### Preparation of the Bituminous Composition

The present invention also concerns a process for the preparation of a bituminous composition as defined above. The process includes contacting, at a temperature of from 70° C. to 220° C., at least one bitumen base, at least one compound of general Formula (I), at least one compound of general Formula (II).

In some exemplary embodiments, the process for the preparation of a bituminous composition includes contacting, at a temperature of from 70° C. to 220° C., at least one bitumen base with only a compound of general Formula (I) or a compound of general Formula (II), but not both.

Compounds of general Formula (I) and (II) may be added to the bitumen simultaneously or by successive additions.

Preferably, compounds of general Formula (I) and (II) are contacted with the bitumen base at a temperature ranging from 90° C. to 180° C., more preferably from 110° C. to 180° C.

The bitumen base used in the above-defined process may be pure or additivated, notably with a polymer, in an anhydrous or emulsion form, or even in association with agglomerates in the form of a bituminous mix.

Advantageously, the process for the preparation of a bituminous composition a comprises the following steps:

a. the introduction of the bitumen base in a reactor equipped with mixing means and its heating at a temperature ranging from 70° C. to 220° C., preferably from 90° C. to 180° C., more preferably from 110° C. to 180° C.,

b. the simultaneous and/or successive additions of the compounds of general Formula (I) and (II), and

c. the mixture of the bituminous composition at a temperature ranging from 70° C. to 220° C., preferably from 90° C. to 180° C., more preferably from 110° C. to 180° C., until obtaining a homogenous composition.

In one or more exemplary embodiments, the process for the preparation of a bituminous composition a comprises the following steps:

a. the introduction of the bitumen base in a reactor equipped with mixing means and its heating at a temperature ranging from 70° C. to 220° C., preferably from 90° C. to 180° C., more preferably from 110° C. to 180° C.,

b. the additions of one of the compounds of general Formula (I) and (II), and

c. the mixture of the bituminous composition at a temperature ranging from 70° C. to 220° C., preferably from 90° C. to 180° C., more preferably from 110° C. to 180° C., until obtaining a homogenous composition.

### Applications

Another aspect of the present invention relates to the use of a bituminous composition according to the invention for different industrial applications, notably as a binder or coating.

The bituminous composition according to the invention is particularly advantageous for the preparation of a sealing coating, an insulating coating, a roofing material, a membrane, or an impregnation layer.

The bituminous composition according to the invention is particularly suitable for the preparation of a sealing coating, a noise barrier, an isolation membrane, a surface coating, a carpet tile, an impregnation layer, or a roofing material.

More particularly, the bituminous composition according to the invention is suitable for the preparation of a roofing material, notably for the preparation of a roofing shingle.

### Roofing Shingle Application

It was discovered that providing a non-oxidized bitumen base with at least one of a compound of general Formula (I) and/or at least one of a compound of general Formula (II) allows obtaining a bituminous composition which is suitable for the preparation of a roofing shingle.

The bituminous composition according to the invention may be used as an asphalt shingle coating. In some exemplary embodiments, the asphalt shingle coating comprises the bituminous composition disclosed above, comprising at least one additive of general Formula (I) and at least one additive of general Formula (II). In one or more exemplary embodiments, the asphalt shingle coating comprises the bituminous composition disclosed above, comprising at least one additive of general Formula (I) or at least one additive of Formula (II).

In some exemplary embodiments, the asphalt shingle coating comprises a bituminous composition including one or more additives from general Formula (I) and general Formula (II) in a total amount from 0.1 to 10% by weight of the bituminous composition, including from 0.25 to 8.0% by weight, 0.3 to 7.0% by weight, and 0.3 to 5.0% by weight. In some exemplary embodiments, the additive(s) from general Formula (I) are present in an amount from about 0.1 to 5.0% by weight, including 0.2 to 3.0 wt. %, 0.3 to 2.5 wt. %, and 0.4 to 1.5 wt. %. In some exemplary embodiments, the additive(s) from general Formula (II) are present in an amount from about 0 to 5.0% by weight, including 0.1 to 3.0 wt. %, 0.25 to 2.5 wt. %, and 0.4 to 1.5 wt. %.

The shingle coating composition is then mixed with a filler, such as a filler of finely ground inorganic particulate matter, such as ground limestone, dolomite or silica, talc, sand, cellulosic materials, fiberglass, calcium carbonate, or combinations thereof. In some exemplary embodiments, the one or more fillers is included in at least 10 wt. %, based on the total weight of the shingle coating composition. In some exemplary embodiments, the one or more fillers are included in about 20 wt. % to about 90 wt. %, including about 25 wt. % to about 85 wt. %, about 50 wt. % to about 80 wt. % and about 65 wt. % to about 75 wt. %, based on the total weight of the shingle coating composition. In some exemplary embodiments, the shingle coating composition further comprises various oils, waxes, fire retardant materials, and other compounds conventionally added to asphalt compositions for roofing applications.

The process for the preparation of a roofing shingle from a bituminous composition according to the invention may generally comprise the following steps:

a. providing a base material sheet,

b. coating the front and back of the base material sheet with the shingle coating composition according to the invention,

c. optionally, applying a backdust material to one side of the base material sheet, and

d. optionally, applying at least on part of the surface of the shingle coating, protective and/or decorative granules.

The step b) of coating as defined above may be realized according to any known method.

The process for the preparation of a roofing shingle as defined above may also comprise, between steps a) and b), an additional step of heating the bituminous composition according to the invention at a temperature ranging from 100° C. to 180° C., such as from 120° C. to 160° C.

In one exemplary embodiment, a base material sheet, such as any of the base materials described above, and a shingle coating composition, such as any of the shingle coating compositions described above, are selected and combined in a shingle to enhance the mechanical properties of the shingle. For example, the shingle with the base material and shingle coating composition can have enhanced properties compared to shingles having the same base material, but the shingle is made with an oxidized asphalt (i.e. not the bituminous composition disclosed herein). The shingle can comprise one or more of any of the base materials described herein and one or more of any of the shingle coating compositions disclosed herein.

A roofing shingle which may be obtained from a shingle coating composition according to the invention may typically comprises at least one sheet made of a shingle coating composition according to the invention. Roofing shingles may have a headlap region and a prime region. The headlap region may be ultimately covered by adjacent shingles when installed upon a roof. The prime region will be ultimately visible when the shingles are installed upon a roof.

The base material sheet may be any type of base material sheet known for use in reinforcing bitumen-based roofing material, such as woven or non-woven textile materials. In some exemplary embodiments, the base material sheet comprises a nonwoven web of glass fibers. Alternatively, the substrate may be a scrim or felt of fibrous materials such as mineral fibers, cellulose fibers, rag fibers, mixtures of mineral and synthetic fibers, or the like.

Advantageously, the shingle coating composition according to the invention may be directly coated on the surface on the base material sheet to form a bituminous sheet.

According to some exemplary embodiments, the roofing shingle further comprises, between the base material sheet and the bituminous sheet, at least one intermediary layer of another material.

The roofing shingle defined above may further comprise, at least on part of its surface, protective and/or decorative granules. The granules shield the bituminous composition from direct sunlight, offer resistance to fire, and provide texture and color to the shingle. The granules generally involve at least two different types of granules. Headlap granules are applied to the headlap region. Headlap granules are relatively low in cost and primarily serve the functional purposes of covering the underlying bitumen material for a consistent shingle construction, balancing sheet weight, and preventing overlapping shingles from sticking to one another. Colored granules or other prime granules are relatively expensive and are applied to the shingle at the prime regions. Prime granules are disposed upon the bitumen strip for both the functional purpose of protecting the underlying bitumen strip and for providing an aesthetically pleasing appearance of the roof.

The shingle coating composition according to the invention is advantageous in that it can be fully or partially recycled as road binder. In particular, the shingle coating composition according the invention is advantageous in that it permits the preparation of roofing shingles with an improved recyclability.

Additionally, the shingle coating composition disclosed herein provides a roofing material with improved impact resistance, which is demonstrated by a standard method, UL 2218, “Standard for Impact Resistance of Prepared Roof Covering Materials”, Underwriters Laboratories, May 31, 1996. In this method, the roofing material is secured to a test deck and a steel ball is dropped vertically through a tube onto the upper surface of the roofing material. The roofing material can be tested at four different impact force levels: Class 1 (the lowest impact force) through Class 4 (the highest impact force). The force of impact in the different classes is varied by changing the diameter and weight of the steel ball, and the distance the ball is dropped. For example, the Class 1 test uses a steel ball having a diameter of 1.25 inches (32 mm) weighing 0.28 pounds (127 g) that is dropped a distance of 12 feet (3.7 m), while the Class 4 test uses a steel ball having a diameter of 2 inches (51 mm) weighing 1.15 pounds (521 g) that is dropped a distance of 20 feet (6.1 meters). After the impact, the roofing material is inverted and bent over a mandrel in both the machine and cross directions, and the lower surface of the roofing material is examined visually for any evidence of an opening or tear. A 5× magnification device may be used to facilitate the examination of the roofing material. If no evidence of an opening is found, the roofing material passes the impact resistance test using the UL 2218 test method.

A roofing material utilizing the shingle coating composition of the present inventive concepts demonstrates an increased impact resistance of at least 1 UL 2218 class, compared with an otherwise identical roofing material including an oxidized asphalt coating composition.

A roofing material utilizing the shingle coating composition of the present inventive concepts passes at least the Class 3 impact resistance test using the UL2218 test method. In some exemplary embodiments, the roofing material utilizing the shingle coating composition of the present inventive concepts passes the Class 4 impact resistance test, using the UL2218 test method.

A roofing material utilizing the shingle coating composition of the present inventive concepts further demonstrates an increased shingle durability, in accordance with ASTM D4798. ASTM D4798 involves accelerated weathering of an asphalt material using a Xenon-Arc lamp. A thin film of the asphalt material to be tested is applied to an aluminum panel and mounted inside the accelerated weathering test device. 24 hours of exposure is defined as one cycle, sometimes referred to as one day in the device. Accelerated weathering test devices are sometimes called “weather-o-meters” or “WOMs”. The endpoint of this test is defined by ASTM D1670 and involves determining 10% or more of the asphalt film to have cracked, using photo-sensitive paper to capture the arc-flash of the aluminum metal in a dark room.

A roofing material utilizing the shingle coating composition of the present inventive concepts further demonstrates improved granule adhesion according to a scrub test, wherein shingle mimics are coated with asphalt (both oxidized and in accordance with the inventive shingle coating composition) on one side and then coated with granules. Specifically, the scrub test is detailed in ASTM D4977/D4977M, which measures the weight of displaced granules (or scrub loss). A shingle sample is weighed prior to testing and a metal bristled brush with a specified weight is then passed over the shingle for 50 passes. After 50 passes are complete, the shingle sample is weighed again. The mass loss after this test is the reported value of displaced granules (or scrub loss).

Shingle samples comprising the inventive shingle coating composition described herein demonstrated lower granule mass loss as a result of the scrub test, compared to shingle samples utilizing a conventional oxidized or polymer modified coating composition. Specifically, a shingle comprising the inventive shingle coating composition demonstrates granule loss of less than 0.40 grams after 8 weeks of wet aging ASTM D4977/D4977M. In some exemplary embodiments, a shingle comprising the inventive shingle coating composition demonstrates granule loss of less than 0.3 grams, or less than 0.20 grams after 8 weeks of wet aging ASTM D4977/D4977M.

A roofing material utilizing the shingle coating composition of the present inventive concepts further demonstrates the ability to be applied at a reduced temperature, compared to traditional oxidized coating compositions. Generally, traditional oxidized coating is applied at about 390° F.+/−5° F. (198.89° C.+/−5° C.). In contrast, the inventive shingle coating composition may be applied at temperatures less than about 350° F. (176.67° C.), including less than about 330° F. (165.56° C.), less than about 315° F. (157.22° C.), less than about 305° F. (151.67° C.), and less than about 300° F. (148.89° C.). In some exemplary embodiments, the inventive shingle coating may be applied at temperatures between about 260° F. to about 300° F. (126.67° C. to about 148.89° C.).

A roofing material utilizing the shingle coating composition of the present inventive concepts further demonstrates improved tear strengths, compared to shingles produced using traditional oxidized coating compositions. Particularly, in some exemplary embodiments, the shingle tear strengths are sufficiently high to pass ASTM D3462, which lists a minimum of 16.7 N (1700 g-force).

A roofing material utilizing the shingle coating composition of the present inventive concepts further demonstrates a number of additional improvements, such as cold weather flexibility (based on the Mandrel bend test), improved adhesion of nail reinforcement layer to the coating composition (based on the probe tack test, generally described at http://www.stevenabbot.co.uk/practical-adhesion/psa-testing.php), potential to run the manufacturing line at higher speeds or filler levels, reduced emissions and energy consumption during production (due to the reduced temperature at coating application), improved resistance to bundle sticking at high temperatures (based on lap shear test, large oven bundle sticking test), and reduced nail blow-through. The shingle coating composition according to the subject inventive concepts further may demonstrate reduced life cycle impact (due to reduced emission and energy consumption). The reduced coating temperature and reduction in the use of air blowing to produce the coating composition may result in a decrease of emissions and energy consumption from production of the proposed shingles compared to the production of shingles using oxidized coatings.

Additionally, the shingle coating composition provides increased supply flexibility to meet the requirements of ASTM D 3462 (penetration of 15 dmm or greater). Soft fluxes suitable for oxidation are less available now than they have been historically, making the production of oxidized coatings more challenging. Use of paving grade asphalt bases will increase the available sources to make asphalt coatings, by achieving ASTM D 3462 requirements through modification rather than blending different asphalt sources and oxidizing the blend (or single source).

The shingle coating composition of the present inventive concepts itself provides a number of unexpected improvements, such as a reduction in blow loss. Oxidized asphalt coatings typically lose about 1-5% by weight of coating mass during the oxidation process. This loss is known as blow loss. For a material that does not go through oxidation, there is no blow loss. The inventive shingle coating composition avoids blow loss by using modification instead of oxidation to achieve the desired coating properties.

The shingle coating composition further demonstrates a reduced viscosity at various temperatures, compared to that of traditional oxidized asphalt coatings. A reduction in viscosity allows the composition to flow more easily and may allow for increased speed of coating application during shingle production.

Additionally, the shingle coating composition is completely recyclable. Since the inventive shingles use a non-oxidized asphalt coating, the asphalt will be less oxidized at the end of production and likely at the end of the product's usable life. In either instance, the use of the recycled asphalt shingles (RAS) from the proposed formulation may be less likely to crack since cracking in pavements with recycled materials is known to occur when very highly oxidized materials are included in the pavement.

The various embodiments, alternative forms, preferences and advantages described above for each of the subject matters of the invention apply to all the subject matters of the invention and can be taken separately or in combination.

The invention is illustrated by the following non-limiting examples.

### EXAMPLES

In the following examples, the percentages are indicated by weight, unless otherwise specified.

### Example 1

### Material and Methods:

The rheological and mechanical characteristics of the compositions to which reference is made in these examples are measured by the methods listed in Table 1.

TABLE 1

| | | | Measurement |
|---|---|---|---|
| Property | Abbreviation | Unit | standard |
| Needle penetrability at | P25 | 1/10 mm | NF EN 1426 |
| 25° C. | | | |
| Ring-and-ball softening | RBT | ° C. | NF EN 1427 |
| temperature | | | |
| Viscosity at 160° C. | V₁₆₀ | mPa · s | NF EN 13702 |
| Maximum Force | Fₘₐₓ | N | detailed protocol |
| | | | here-after |
| Deformability at 65° C. | Def. | % | detailed protocol |
| | | | here-after |

### Bitumen Base:

The bituminous base B₀ is an oxidized bitumen base having a penetrability P₂₅ of 16 1/10 mm, a Ring and Ball Softening temperature (RBT) of 95° C. The bitumen base B₀ is commercially available from OWENS CORNING under the name BURA Type 3.

The bitumen base B₀ is classically used for the preparation of asphalt shingles and constitutes in the following examples a comparative bitumen base (reference).

The bituminous compositions were prepared from the following bitumen bases:

B₁: bitumen base of PG64-22 grade, having a penetrability P₂₅ of 59 1/10 mm, an RBT of 50° C.
B₂: bitumen base of PG70-10 grade, having a penetrability P₂₅ of 30 1/10 mm, an RBT of 53.8° C.
B₃: bitumen base of PG67-22 grade.
B₄: bitumen base of PG70-10 grade.
B₅: partially oxidized bitumen base of PG64-22, having a penetrability P₂₅ of 20 1/10 mm, and an RBT of 65.55° C.
B₆: partially oxidized bitumen base having a penetrability of P₂₅ of 20 1/10 mm, and an RBT of 76.67° C.
B₇: propane deasphalted asphat.

### Chemical Additives:

Additive A₁ of Formula (I): 2′,3-bis[(3-[3,5-di(tert-butyl)-4-hydroxyphenyl]propionyl)] propionohydrazide (CAS 32687-78-8), sold by BASF under the Irganox MD 1024 brand,

Additive A₂ of Formula (II): N,N′-ethylenedi(stearamide), sold by Croda under the name Crodawax 140®.

Additive A₃ of Formula (I): 1,2-Bis(3,5-di-tert-butyl-4-hydroxyhydrocinnamoyl) hydrazine, sold by Rianlon under the name RIANOX MD-1024.

Additive A₄ of Formula (II): N,N′-ethylenedi(stearamide), sold by Acme Hardesty.

The bitumen base was introduced into a reactor maintained at a temperature of 160° C. with stirring at 300 revolutions/min for two hours. The additives were subsequently introduced into the reactor. The contents of the reactor were maintained at 160° C. with stirring at 300 revolutions/min for 45 minutes.

### Protocol for the Measurement of the Maximum Force (Fₘₐₓ):

The bituminous composition was tested to evaluate the compression strength of the composition at a specific mass having a constant applied velocity. The compressive strength was evaluated by the measurement of the maximum force (Fₘₐₓ) applied on the surface of the bituminous composition without observing any deformation of the bituminous composition. The test was executed at a temperature of 50° C.

The maximum force (Fₘₐₓ) was measured with a texture analyzer commercialized by LLOYD Instruments under the name LF Plus and equipped with a thermal enclosure. The piston of the texture analyzer is a cylinder having a diameter of 25 mm and a height of 60 mm.

A cylindrical metallic box comprising 60 g of the bituminous composition was introduced inside the thermal enclosure settled at a temperature of 50° C. The cylindrical piston was initially placed in contact with the superior surface of the bituminous composition. Then, the piston was put in a vertical movement to the bottom of the box, at a constant velocity equal to 1 mm/min and over a calibrated distance of 10 mm in order to apply to the superior surface of the bituminous composition a compression strength. The texture analyzer measures the maximum force (Fₘₐₓ) applied by the piston on the surface of the bituminous composition at 50° C.

The determination of the maximum force (Fₘₐₓ) allows evaluating the capacity of the bituminous composition to resist to the deformation. The higher the maximal force (Fₘₐₓ), the better the compression strength of the bituminous composition.

### Protocol for the Measurement of the Deformability (Def.):

The bituminous composition to be analyzed was first poured in a circular silicon mold and then cooled at ambient temperature for at least 1 hour before being unmolded.

The lower plate of an ANTON PAAR Physica MCR 301 plate-plate rheometer was heated at a temperature of 65° C. Once the temperature was reached, the rheometer was equipped with a PP25 mobile before being blanked. The gap of the rheometer is fixed at 2 mm. The unmolded solid bituminous composition was placed on the heated plate. The height of the mobile was then adjusted to 2.1 mm and the surplus of bituminous composition overflowing under the mobile was cut out by using a heated spatula. The gap of the rheometer was finally re-adjusted at 2 mm and the bell, previously heated at 65° C., was placed over the whole instrument. The measurement was launched as soon as the rheometer indicated a normal force value equal to 0 N. The constraint applied to the sample was set at 100 Pa and the acquisition time at 7200 s.

### Preparation of the Compositions:

The bituminous compositions C₁ to C₈ corresponding to the mixtures defined in the following Table 2 are prepared according to the above-described protocol.

Compositions C₁, C₂, C₅, C₆ and C₈ are according to the invention.

Compositions C₃, C₄, and C₇ are comparative.

TABLE 2

| Compositions | B₁ (%) | B₂ (%) | B₇ (%) | A₁ (%) | A₂ (%) | A₃ (%) | A₄ (%) |
|---|---|---|---|---|---|---|---|
| C₁ | 96.35% | — | | 0.65% | 3% | | |
| C₂ | 98% | — | | 1% | 1% | | |
| C₃ | 99.35% | — | | 0.65% | — | | |
| C₄ | 97% | — | | — | 3% | | |
| C₅ | — | 96.35% | | 0.65% | 3% | | |
| C₆ | — | 97% | | 1% | 2% | | |
| C₇ | — | 97% | | — | 3% | | |
| C₈ | 86.35% | | 10% | | | 0.65% | 3% |

### Rheological and Mechanical Properties of the Bitumen Compositions:

The rheological and mechanical properties of the compositions C₁ to C₈ and of the bitumen bases B₀ to B₂ have been measured according to the above-defined protocols. The results are given in the following Table 3.

TABLE 3

| | P25 | RBT | Viscosity V₁₆₀ | Fₘₐₓ | Def. |
|---|---|---|---|---|---|
| | (1/10 mm) | (° C.) | (mPa · s) | (N) | (%) |
| B₀ | 16 | 95 | 4100 | 48.1 | 130.8 |
| B₁ | 59 | 50 | 155 | 0.8 | 456200 |
| C₁ | 29 | 101.5 | 146 | 68.3 | 4.6 |
| C₂ | 30 | 106 | 152 | 103 | 11 |
| C₃ | 45 | 98.5 | 157 | 48.5 | 256 |
| C₄ | 45 | 95.5 | 127 | 0.9 | 118.6 |
| C₈ | 45 | 97.78 | — | — | — |
| B₂ | 30 | 53.8 | 193 | 1 | 254000 |
| C₅ | 23 | 98.5 | 157 | 80.7 | 4.8 |
| C₆ | 19 | 100 | 170 | 99.4 | 1.4 |
| C₇ | 22 | 94 | 160 | 2 | 289 |

### Penetrability at 25° C.

Compositions C₁ to C₄ and C₈ have a reduced penetrability as compared to the bitumen base B₁ non-specially additivated.

Compositions C₅ to C₆ have a reduced penetrability as compared to the bitumen base B₂ non-specially additivated.

The addition of at least one chemical additive A₁ and A₂ leads to a hardening of the bitumen base.

### Ring-and-Ball Softening Temperature (RBT)

Compositions C₁ to C₄ and C₈ have a significantly increased ring-and-ball softening temperature as compared to the bitumen base B₁.

Compositions C₅ to C₇ have an increased ring-and-ball softening temperature as compared to the bitumen base B₂.

In particular, compositions C₁ to C₈ have a ring-and-ball softening point superior or equal 90° C.

Thus, compositions C₁ to C₈ are suitable as bituminous compositions for the preparation of a roofing shingle.

The highest ring-and-ball temperatures are obtained for the compositions C₁, C₂, C₅, C₆, and C₈ according to the invention.

In particular, compositions C₁, C₂, C₅, C₆ and C₈ according to the invention have a ring-and-ball temperature which is superior to that of the oxidized bitumen B₀.

### Viscosity

The additivation of the bitumen base B₁ or B₂ with at least one chemical additive A1 or A2 does not significantly affect the viscosity of the obtained bituminous composition.

Compositions C₁ to C₈ have an improved viscosity as compared to the oxidized bitumen base B₀. In particular, the viscosity at 160° C. of compositions C₁ to C₈ is more than 20 times inferior to the viscosity of the bitumen base B₀.

### Maximum Force (Fₘₐₓ)

Compositions C₁, C₂, C₅ and C₆ according to the invention have a significantly higher maximum force value (between 68.3 and 103N) as compared to the bitumen bases B₁ and B₂ (respectively, 0.8 and 1N).

According to the results obtained for the compositions C₄ and C₇, we note that the additivation of the bitumen bases B₁ and B₂ with the chemical additive A2, taken alone, does not substantially modify their maximum force value.

Reversely, and according to the results obtained for the composition C₃, the additivation of the bitumen base B₁ with the chemical additive A1, taken alone, leads to an increase of the maximum force value.

The maximum force value of composition C₁, according to the invention, is significantly superior to the maximal force value of composition C₃ which solely comprises the additive A₁.

This demonstrates a synergy between the additives A1 and A2, which results in a surprising increase of the maximum force of the bituminous compositions comprising both additives.

Furthermore, compositions C₁, C₂, C₅ and C₆ according to the invention have an improved maximum force value as compared to the oxidized bitumen base B₀.

The improved maximal force value of the compositions according to the invention allows predicting an improved resistance strength of the compositions according to the invention as compared to compositions C₃, C₄, and C₇.

Asphalt shingles prepared from compositions according to the invention are thus stable during their storage. In particular, the obtained asphalt shingles have an improved creeping resistance as compared to the compositions of the prior art.

### Deformability

According to the results obtained for the compositions C₄, and C₇, we note that the additivation of the bitumen bases B₁ and B₂ with the chemical additive A2, leads to a significant reduction of the deformability of the bitumen bases B₁ and B₂.

Similarly, and according to the results obtained for composition C₃, we note that the additivation of the bitumen base B₁ with the chemical additive A1, taken alone, leads to an even more significant reduction of the deformability of the bitumen base B₁.

Compositions C₁, C₂, C₅ and C₆ according to the invention have an even more significantly reduced deformability (between 1.4 and 11%) as compared to the bitumen bases B₁ and B₂ (respectively, 456 200 and 254 000%).

The combined addition of the additives A1 and A2 leads to a reduction of the deformability of the bitumen bases B₁ and B₂ which is superior to the reduction observed when only one of these two additives is added.

In addition, compositions C₁, C₂, C₅ and C₆, according to the invention, have a significantly reduced deformability as compared to the oxidized bitumen base B₀.

### Example 2: Granule Adhesion

In the Examples below, the previously introduced inventive compositions are as defined above in Example 1.

The bitumen base was introduced into a mixing vessel maintained at the desired mixing temperature and stirred for at least 45 minutes to prepare the inventive coatings for shingle prototype evaluations.

A comparison between Standard Coatings 1 and 2 (SC₁ and SC₂) and exemplary inventive coatings was performed and tested for granule adhesion. The inventive coatings in these Samples were as provided below in Table 4. Compositions S₁-S₁₀ are according to the invention. Shingle coupons were cut and tested to determine the weight of displaced granules (or scrub loss), according to ASTM D4977/D4977M. The shingle coupon is weighed prior to testing, and a metal bristled brush with a specified weight is passed over the shingle coupon for 50 passes. After 50 passes are complete, the shingle coupon is weighed again. The mass loss after this test is the reported value of displaced granules (or scrub loss).

TABLE 4

| Comps. | B₁ (%) | B₃ (%) | B₄ (%) | B₅ (%) | B₆ (%) | A₁ (%) | A₂ (%) | A₃ (%) | A₄ (%) |
|---|---|---|---|---|---|---|---|---|---|
| S₁ | 98.8% | — | | | | 1.2% | — | | |
| S₂ | | 99% | | | | 1.0% | | | |
| S₃ | 99% | | | | | 1.0% | | | |
| S₄ | — | | 97% | | | 1.0% | 2.0% | | |
| S₅ | 99% | | | | | 1.0% | | | |
| S₆ | 96.35% | | | | | 0.65% | 3.0% | | |
| S₇ | | | | 96.35% | | | | 0.65% | 3.0% |
| S₈ | | | | | 96.35% | | | 0.65% | 3.0% |

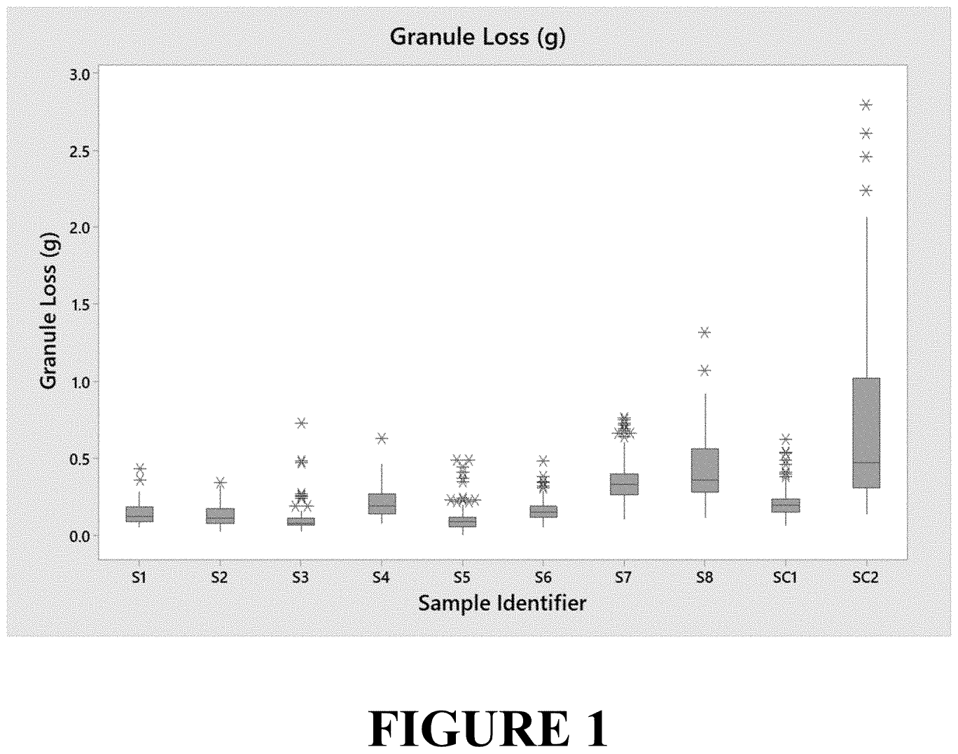

The Samples were tested as produced and the results are illustrated in FIG. 1.

The granule adhesion test results of the inventive coatings were comparable to or, in some cases, better than those of the standard, oxidized coating compositions. Specifically, the measured mass of granules displaced from shingle mimic samples produced using the inventive coating during the ASTM D4977/D4977M test was the same or lower than the mass of granules displaced from the samples produced using standard oxidized coating.

### Example 3: Shingle Durability

Roofing shingle durability was tested in accordance with ASTM-D4798, which measures the cycles to failure (CTF). For this test, an asphalt coating sample is pressed onto an aluminum plate and placed in a “Weather-O-Meter” or “WOM”, where the samples are subject to a cycle of UV radiation and water sprays, intended to mimic the thermal and radiative cycling that a shingle would be exposed to on a roof. The sample is left in the WOM until the sample is determined to fail. Failure is defined as 10% or more cracking observed on a photo paper that captures cracking when the panel is subject to an arc flash in a dark room. The longer the material endures in the WOM without reaching 10% cracking, the longer the coating is expected to last in a shingle.

Table 5 contains several examples of the proposed inventive coating, an oxidized coating sample for reference, and an oxidized B₁ sample (oxidized to reach shingle softening point, a requirement for the test to function properly). The reference numbers listed in Table 5 correspond to those used above in the Examples above.

As shown below, all examples of the inventive coating endure more time in the WOM prior to reaching 10% cracking than do the oxidized paving base or the oxidized coating sample. These results indicate that the inventive shingle coating is more durable in a shingle than oxidized coatings.

TABLE 5

| Sample Description | Days in WOM |
|---|---|
| B₁ | 146.4 |
| B₁ + 1% A₁ | 242 |
| B₁ + 3% A₂ + 0.65% A₁ | 416 |
| B₁ + 1% A₁ | 226 |
| B₁ + 3% A₂ + 0.65% A₁ | 406 |
| B₃ + 1% A₁ | 448 |
| B₃ + 3% A₂ + 0.65% A₁ | 510 |
| Oxidized Coating Sample | 95.4 |

### Example 4: Shingle Tear Strength

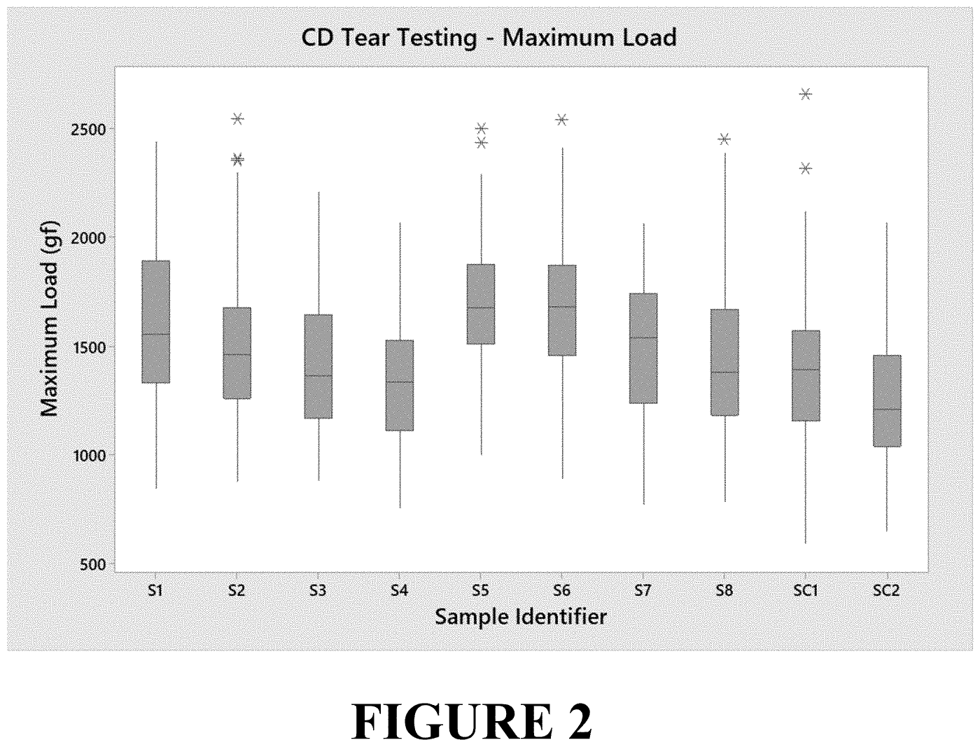

Roofing shingle tear strength was tested in accordance with ASTM D3462, and the results are illustrated in FIG. 2. This test involves the use of a pendulum device to propagate tearing across a shingle sample. A shingle sample is cut to specification, including a precut slit. The sample is conditioned prior to the test and then loaded into the pendulum device. The pendulum is then allowed to fall with gravity, tearing the sample. A scale records the loss of energy by the pendulum which is used to calculate the tearing force in millinewtons and/or grams-force. The compositions tested in this example include shingle mimics made using an oxidized coating as a control and coating prepared according to the inventive concepts. As shingle mimics are not full shingles, the results may be lower than expected from full shingles. The reference numbers used in this Example correspond to those used above in the Examples above.

As illustrated in FIG. 2, Samples S₁-S₈ demonstrated CD tear strengths above 1000 gf, and in some examples, above 1500 gf. The CD tear strength test results of the inventive coatings were comparable to or, in some cases, better than those of the standard, oxidized coating comparisons (SC₁ and SC₂). Specifically, this means that the measured force required to tear the shingle mimic samples produced using the inventive coating during the ASTM D4977/D4977M test was the same or higher than the force required to tear the shingle mimic samples produced using standard oxidized coating, which is known to meet the minimum specification of 1700 gf per ASTM D3462.

### Example 5: Asphalt Coating Viscosity and Temperature of Application

Shingle coating composition viscosity was tested using a Brookfield rotational viscometer. Table 5, below, contains several examples of the proposed inventive coating, a comparative oxidized coating sample C₁, and an asphalt base sample B₁ (as a control). The reference numbers used in this Example correspond to and are consistent with those used in the Examples above.

These results indicate that the inventive formulations reach a viscosity similar to that of the oxidized coating example (at 400° F.) at temperatures between 250 and 300° F. This result would allow for the application of the inventive coating at lower temperatures than required for oxidized coating.

TABLE 5

| | | | B₁ + 3% | | B₁ + 3% | | B₃ + 3% | |
|---|---|---|---|---|---|---|---|---|
| Sample | | B₁ + 1% | A₂ + 0.65% | B₁ + 1% | A₂ + 0.65% | B₃ + 1% | A₂ + 0.65% | |
| Description | B₁ | A₁ | A₁ | A₁ | A₁ | A₁ | A₁ | C₁ |
| Visc. @ 400° | 797 | x | x | x | x | x | x | 407 |
| F. (cP) | | | | | | | | |
| Visc. @ 350° | | 79.5 | 55 | 86 | 64 | 93 | 72.5 | |
| F. (cP) | | | | | | | | |
| Visc. @ 325° | | 132 | 92 | 138 | 110 | 152 | 118 | |
| F. (cP) | | | | | | | | |
| Visc. @ 300° | | 232 | 154 | 240 | 192 | 268 | 204 | |
| F. (cP) | | | | | | | | |
| Visc. @ 275° | | 447 | 280 | 480 | 357 | 545 | 383 | |
| F. (cP) | | | | | | | | |
| Visc. @ 250° | | 967.5 | 588 | 1053 | 770 | 1235 | 800 | |
| F. (cP) | | | | | | | | |
| Visc. @ 225° | | 2425 | 3395 | x | 15680 | N/A | 6000 | |
| F. (cP) | | | | | | | | |
| Viscosity | | | | | | 21 spindle | 21 spindle | |
| Comments: | | | | | | used | used | |
| | | | | | | during | during | |
| | | | | | | Viscosity | Viscosity | |
| | | | | | | testing | testing | |

### Example 6: Shingle Impact Resistance

The impact resistance of roofing shingles produced using the inventive asphalt coating composition was tested in accordance with UL2218, wherein 3 ft.×3 ft. roof decks were evaluated for Class 4 compliance after two impact drops per location (i.e., the standard UL2218 protocol). The Class 4 test utilizes a steel ball (2 inch diameter, 1.15 lb. mass) that is dropped from a height of 20 ft. twice per location (minimum of 6 locations). In order to pass the test, the roof deck covering material, back surface, and underneath layers shall show no evidence of tearing, fracturing, cracking, splitting rupture, crazing, or other evidence of opening through any prepared roof covering layer. The roofing shingles tested were formed using an inventive coating example comprising base asphalt B₁, 3.0 wt. % A₂ and 0.65 wt. % A₁. In this trial, a total of 12 locations were tested and each location passed Class 4 impact resistance compliance.

### Example 7: Granule Adhesion

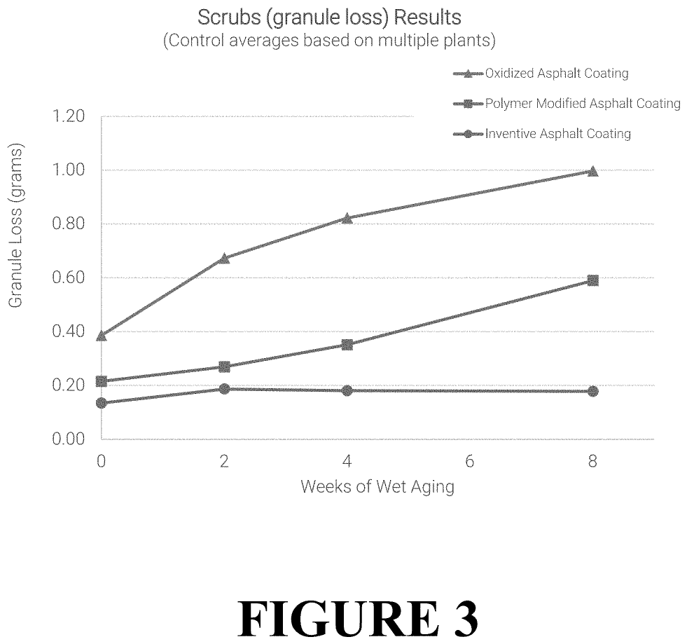

A comparison between a standard oxidized coating (SC₁), a commercial styrene-butadiene-styrene (SBS) polymer modified coating, and an exemplary inventive coating (PG 64-22 bitumen base+3.0 wt. % additive A₄+0.65 wt. % additive A₃) was performed and tested for granule adhesion. Shingle coupons were cut, wet aged for 8 weeks, and tested to determine the weight of displaced granules (or scrub loss), according to ASTM D4977/D4977M. Each shingle coupon was weighed prior to testing, and a metal bristled brush with a specified weight was passed over the shingle coupon for 50 passes. After 50 passes are complete, the shingle coupon was weighed again. The mass loss after this test is the reported value of displaced granules (or scrub loss). FIG. 3 illustrates the granule mass loss in grams of an average of shingle samples over a period of 8 weeks of wet aging. As illustrated, the shingles formed using the inventive coating demonstrated less than 0.5 grams of granule loss over a period of 8 weeks of wet aging. Particularly, the shingles coated with the inventive coating composition demonstrated less than 0.25 grams of granule loss over a period of 8 weeks of wet aging.

The compositions according to the invention are advantageous in that they are suitable for the preparation of asphalt shingles. In fact, compositions according to the invention have a very low penetrability (less than 30 1/10 mm, in some cases) and a ring-and-ball softening point similar to that of an oxidized bitumen base classically used for the preparation of shingles.

Furthermore, the bituminous compositions according to the invention have improved physical properties as compared to an oxidized bitumen base. In particular, the bituminous compositions according to the invention have, compared to an oxidized bitumen base:

a reduced hot viscosity which facilitates the deposition of the asphalt coating on the substrate, and

an improved compression strength (Fₘₐₓ), and

a reduced deformability which both allow obtaining more durable asphalt shingles.

Asphalt shingles prepared from a bituminous composition according to the invention thus have an improved resistance to the deformations induced for example by temperature variations or by stress applied during setting up.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions.

Although several exemplary embodiments of the present invention have been described herein, it should be appreciated that many modifications can be made without departing from the spirit and scope of the general inventive concepts. All such modifications are intended to be included within the scope of this invention and the related general inventive concepts.

1. A coating composition for a roofing material comprising:
about 20 wt. % to about 90 wt. % of a filler material; and
a bituminous composition comprising:
a bitumen base selected from the group consisting of partially oxidized bitumen, non-oxidized bitumen, and deasphalted asphalt; and
0.1 to 10% by weight of at least one compound of general Formula (I), general Formula (II), or combinations thereof, wherein the compound of general Formula (I) comprises:
Ar1-R₁—Ar₂ (I), wherein:
Ar1 and Ar2 represent, independently of one another, an aromatic group comprising from 6 to 20 carbon atoms chosen among a benzene nucleus or a system of condensed aromatic nuclei, said hydrocarbon group being substituted by at least one hydroxyl group and optionally by one or more C₁-C₂₀ alkyl groups, and
R₁ represents an optionally substituted hydrocarbon divalent radical, the main chain of which comprises from 6 to 20 carbon atoms and at least one group chosen from the amide, ester, hydrazide, urea, carbamate and anhydride functional groups; and
the compound of general Formula (II) comprises:
R₂—(NH)ₙCONH—X—(NHCO)ₚ(NH)ₙ—R′2 (II)
wherein the R₂ and R′₂ groups, which are identical or different, represent a hydrocarbon chain comprising from 1 to 22 carbon atoms which is optionally substituted and which optionally comprises one or more heteroatoms, such as N, O or S, and R₂ can be H,
the X group represents a hydrocarbon chain comprising from 1 to 22 carbon atoms which is optionally substituted and which optionally comprises one or more heteroatoms, such as N, O or S, and
n and p are integers having a value of 0 or 1, independently of one another.

2. The coating composition of claim 1, wherein the compound of general Formula (I) is 2′,3-bis[(3-[3,5-di(tert-butyl)-4-hydroxyphenyl]propionyl)]propionohydrazide.

3. The coating composition of claim 1, wherein the compound of general formula (II) is chosen from compounds of general Formula (IIA):
R₂—CONH—X—NHCO—R′₂ (IIA)
wherein R₂, R′₂ and X are as defined in claim 1.

4. The coating composition of claim 1, comprising from 0.4 to 5% by weight of one or several compounds of general Formula (I), with respect to the total weight of the bituminous composition.

5. The coating composition of claim 1, comprising from 0.5% to 6% by weight of one or several compounds of general Formula (II), with respect to the total weight of the bituminous composition.

6. The coating composition of claim 1, comprising from 89 to 99.1% by weight of a bitumen base, from 0.4 to 5% by weight of one or several additives of general Formula (I), and from 0.5 to 6% by weight of one or several additives of general Formula (II), with respect to the total weight of the bituminous composition.

7. The coating composition of claim 1, comprising from 94 to 98.6% by weight of a bitumen base, from 0.4 to 1% by weight of one or several additives of general Formula (I), and from 1 to 5% by weight of one or several additives of general Formula (II), with respect to the total weight of the bituminous composition.

8. The coating composition of claim 1, wherein the filler material comprises on or more of ground limestone, dolomite, silica, talc, sand, cellulosic materials, fiberglass, or calcium carbonate.

9. The coating composition of claim 1, wherein the composition has a penetrability at 25° C., measured according to standard EN 1426, from 15 to 30 1/10 mm.

10. The coating composition of claim 1, wherein the composition has a ring-and-ball softening point, measured according to standard EN 1427, of from 80 to 120° C.

11. A roofing material comprising:
a base material; and
a coating composition applied to at least one side of the base material, said coating composition comprising:
a filler material; and
a bituminous composition comprising:
a bitumen base selected from the group consisting of partially oxidized bitumen, non-oxidized bitumen, and deasphalted asphalt; and
0.1 to 10% by weight of at least one compound of general Formula (I), general Formula (II), or combinations thereof:
wherein the compound of general Formula (I) comprises:
Ar1-R₁—Ar₂ (I), wherein:
Ar1 and Ar2 represent, independently of one another, an aromatic group comprising from 6 to 20 carbon atoms chosen among a benzene nucleus or a system of condensed aromatic nuclei, said hydrocarbon group being substituted by at least one hydroxyl group and optionally by one or more C₁-C₂₀ alkyl groups, and
R₁ represents an optionally substituted hydrocarbon divalent radical, the main chain of which comprises from 6 to 20 carbon atoms and at least one group chosen from the amide, ester, hydrazide, urea, carbamate and anhydride functional groups; and
the compound of general Formula (II) comprises:
R₂—(NH)ₙCONH—X—(NHCO)ₚ(NH)ₙ—R′2 (II)
wherein the R₂ and R′₂ groups, which are identical or different, represent a hydrocarbon chain comprising from 1 to 22 carbon atoms which is optionally substituted and which optionally comprises one or more heteroatoms, such as N, O or S, and R₂ can be H,
the X group represents a hydrocarbon chain comprising from 1 to 22 carbon atoms which is optionally substituted and which optionally comprises one or more heteroatoms, such as N, O or S, and
n and p are integers having a value of 0 or 1, independently of one another.

12. The roofing material of claim 11, wherein the roofing material comprises a roofing shingle.

13. The roofing material of claim 12, wherein the roofing shingle has an average granule loss of less than 0.4 grams after 8 weeks of wet aging in accordance with ASTM D4977/D4977M.

14. The roofing material of claim 11, wherein the compound of general Formula (I) is 2′,3-bis[(3-[3,5-di(tert-butyl)-4-hydroxyphenyl]propionyl)]propionohydrazide.

15. The roofing material of claim 11, wherein the compound of general formula (II) is chosen from compounds of general Formula (IIA):
R₂—CONH—X—NHCO—R′₂ (IIA)
wherein R₂, R′₂ and X are as defined in claim 11.

16. The roofing material of claim 11, comprising from 0.1 to 5% by weight of one or several compounds of general Formula (I), with respect to the total weight of the bituminous composition.

17. The roofing material of claim 11, comprising from 0.5% to 6% by weight of one or several compounds of general Formula (II), with respect to the total weight of the bituminous composition.

18. The roofing material of claim 11, wherein the filler material comprises on or more of ground limestone, dolomite, silica, talc, sand, cellulosic materials, fiberglass, or calcium carbonate.

19. The roofing material of claim 11, wherein the bitumen base comprises partially oxidized bitumen having a penetrability P₂₅ of 18 1/10 mm to 22 1/10 mm.

20. The roofing material of claim 11, wherein the coating composition has a penetrability at 25° C., measured according to standard EN 1426, from 15 to 30 1/10 mm.

21. The roofing material of claim 11, wherein the coating composition has a ring-and-ball softening point, measured according to standard EN 1427, of from 80 to 120° C.

22. A roofing shingle comprising:
a base material; and
a shingle coating composition applied to at least one side of the base material, said shingle coating composition comprising:
a filler material; and
a bituminous composition comprising at least:
a bitumen base, selected from the group consisting of partially oxidized bitumen, non-oxidized bitumen, and deasphalted asphalt; and
at least one of a compound of general Formula (I), general Formula (II), or combinations thereof, wherein the compound of general Formula (I) comprises:
Ar1-R₁—Ar₂ (I), wherein:
Ar1 and Ar2 represent, independently of one another, an aromatic group comprising from 6 to 20 carbon atoms chosen among a benzene nucleus or a system of condensed aromatic nuclei, said hydrocarbon group being substituted by at least one hydroxyl group and optionally by one or more C₁-C₂₀ alkyl groups, and
R₁ represents an optionally substituted hydrocarbon divalent radical, the main chain of which comprises from 6 to 20 carbon atoms and at least one group chosen from the amide, ester, hydrazide, urea, carbamate and anhydride functional groups; and
the compound of general Formula (II) comprises:
R₂—(NH)ₙCONH—X—(NHCO)ₚ(NH)ₙ—R′2 (II)
wherein the R₂ and R′₂ groups, which are identical or different, represent a hydrocarbon chain comprising from 1 to 22 carbon atoms which is optionally substituted and which optionally comprises one or more heteroatoms, such as N, O or S, and R₂ can be H,
the X group represents a hydrocarbon chain comprising from 1 to 22 carbon atoms which is optionally substituted and which optionally comprises one or more heteroatoms, such as N, O or S, and
n and p are integers having a value of 0 or 1, independently of one another, wherein the roofing shingle passes UL 2218 Class 4 impact resistance test.
